(19) United States
(12) Patent Application Publication
(10) Pub. No.: US 2009/0317225 A1
(43) Pub. Date: Dec. 24, 2009

(54) Clampable container system

(75) Inventor: Alex D. Bevier, Naches, WA (US)

Correspondence Address: INTERNATIONAL PAPER COMPANY, 6285 TRI-RIDGE BOULEVARD, LOVELAND, OH, 45140, US

(73) Assignee: Weyerhaeuser Co., Federal Way, WA (US)

(21) Appl. No.: 12/144,190

(22) Filed: Jun. 23, 2008

(51) Int. Cl. B65G 57/22

(52) U.S. Cl. 414/791.6

(57) ABSTRACT

A layer of containers which can be moved by a clamp lift truck. The containers are held together by a layer lift sheet which is attached to the bottoms of the containers and holds them together along their sides and ends. The layer lift sheet has perforations that align with the juxtaposed sides and ends of the containers.

This application is directed to a corrugated container assembly which can withstand horizontal compression loads.

Corrugated containers are designed to withstand vertical compression loads because they are usually stacked several containers high on a pallet and several pallets high. This was no problem because the pallets were moved by lift trucks which lifted the entire pallet when moving the pallet load.

The advent of clamp lift trucks has created a problem. Clamp lift trucks are used at distribution centers to take pallets of containers that contain the same product and create new pallets of mixed products. For example, in a distribution center for agricultural products that making up pallets for grocery stores, the boxes of oranges on a pallet of oranges would be placed on separate pallets and combined with containers of other fruit or vegetables.

The clamp lift trucks do not lift the containers from the bottom. The clamp lift trucks grasp a layer of containers on the side and apply enough horizontal pressure to hold the containers while moving them. Usually the containers are several wide so enough pressure must be placed on the outside containers to hold the containers together during movement. Most of this pressure is applied to the upper section of each of the containers. Containers are not designed to withstand this horizontal pressure. In addition, many containers open on the top and no longer have upper lids or top panels which might help in withstanding the horizontal pressure. The inability of the top of the container to withstand the horizontal pressure combined with the weight of the containers as the force of gravity forces them downwards causes them to pull apart or gap at the bottom.

This pressure can be passed to the contained product and create problems. One answer has been to place more material in the upper section of the container or to use heavier material in the manufacture of the container. This increases the cost of the container.

### BRIEF DESCRIPTION OF THE DRAWINGS

FIG. 1 is a front plan view of a layer two containers wide clamped by the clamps of a lift truck.

FIG. 2 is a top plan view of a layer lift sheet.

FIG. 3 is a isometric exploded view showing the positioning of a layer lift sheet with a layer of containers.

FIG. 4 is a bottom isometric view of a layer of containers with a layer lift sheet in place.

FIG. 5 is a front plan view of a layer three containers wide clamped by the clamps of a lift truck.

FIG. 6 is a bottom isometric view of a layer of containers illustrating various sizes of lift sheet attached to the bottom of the container.

### DETAILED DESCRIPTION

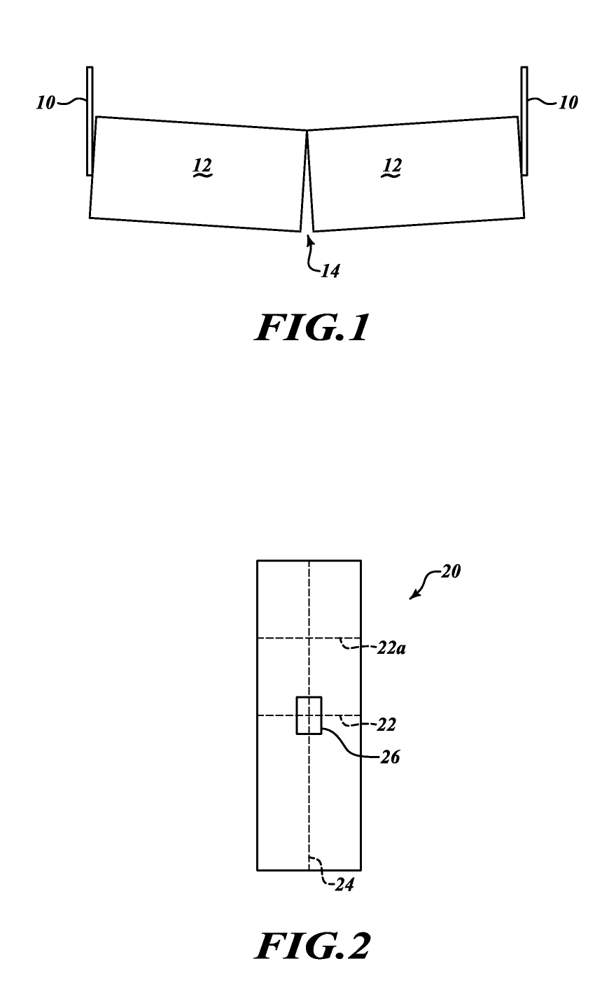

FIG. 1 shows how a layer of containers is presently picked by a side clamping device.

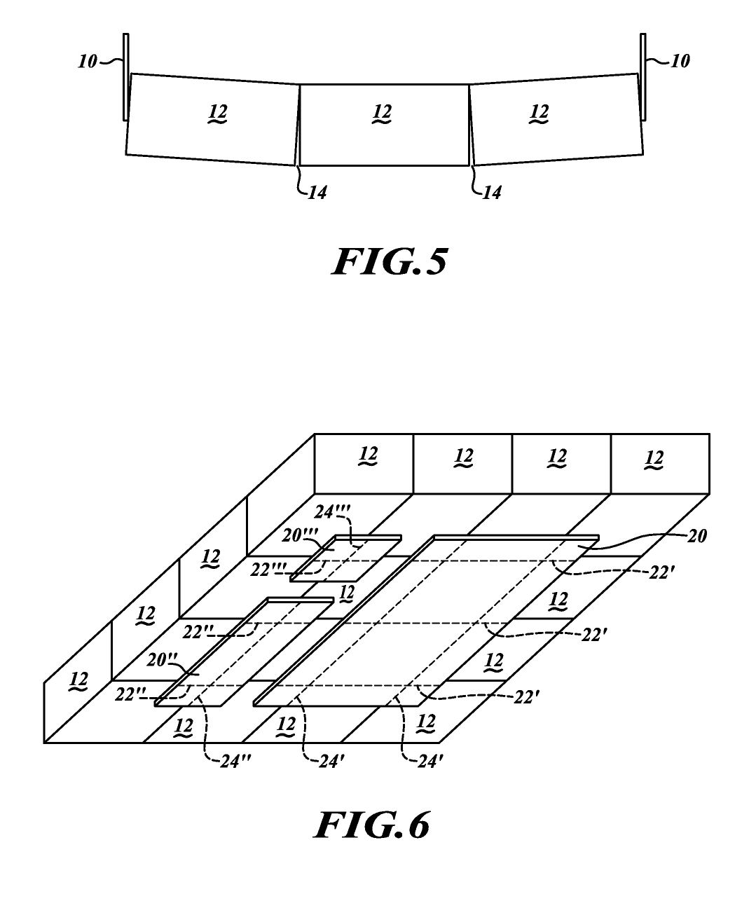

The clamping device 10 holds the containers 12 by the sides. The containers in a layer may be arrayed side to side and end to end, and sometimes the ends of the containers in one row are against the side of the containers in the adjacent row. Although the present application illustrates the system with four containers, there can be twenty-four or more containers in a pallet layer. Many containers are open at the top, no longer having tops or closures. The pressure of the clamp 10 is in a horizontal direction. This pressure at the top of the containers often causes the containers to pull apart or gap at the bottom as shown at 14. There is a concern of the containers dropping from the clamp during transport. There are only two containers between clamps illustrated in FIG. 2, but it will be appreciated that the possibility of containers dropping from the layer becomes greater when there are five or six containers between the clamps. This is illustrated in FIG. 5 showing a pallet layer three containers wide. It can be seen that there is a possibility of the center container dropping. There is also a concern about crushing the contents of the containers because of the amount of pressure placed on the containers. The standard method for handling these concerns is to increase the weight and thickness of the liners and medium.

FIG. 2 is a top plan view of a layer lift sheet, which hold the bottoms of the containers together when clamped. This prevents the containers from pulling apart during transport by the clamp lift truck. The layer lift sheet 20 is a sheet of corrugated or fiberboard material that is attached, by adhesive or staples or other means, to the bottom of a layer of containers. The layer lift sheet 20 connects the containers in a layer together at their intersections. 20 has the length and width to straddle the intersection between adjacent containers in a pallet layer and hold adjacent containers together. The layer lift sheet is affixed to the bottoms of the containers in the layer.

The layer lift sheet 20 is divided by transverse and longitudinal perforations or slits 22 and 24. These perforations or slits are spaced to align with the width and length of the containers in the layer, allowing the containers to be separated from other containers in the layer at the point of use. The layer lift sheet can be manufactured at the same time as the containers and the perforations sized for the containers. There usually are only a few configurations of containers in a pallet layer and the size of the containers are known. The perforations in the layer lift sheet can be spaced to accommodate these configurations.

The layer lift sheet can also have apertures 26 which align with any apertures in the containers in the layer.

The layer sheet is fiberboard or corrugated board.

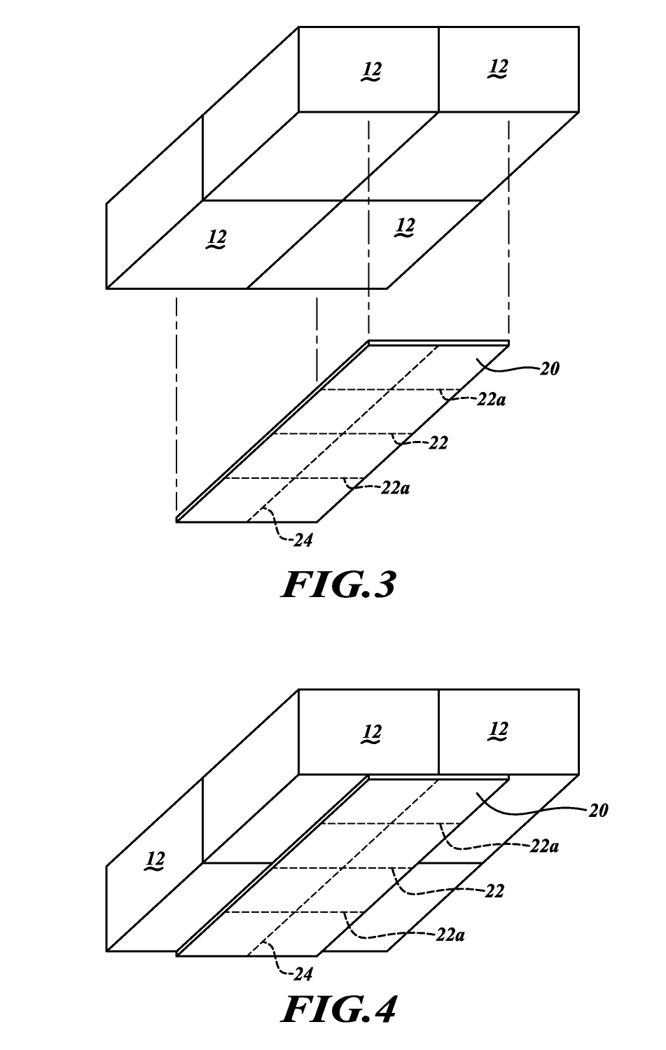

FIGS. 3 and 4 show a layer of containers 12 with clamp sheet 20 affixed to the bottoms of the containers. The perforations or slits 22 and 24 are aligned with the sides and ends of the containers so the containers may be separated at the point of use. Additional perforations or slits 22 and 24 may be present to accommodate other container configurations. Apertures 26 are aligned with the apertures in the bottoms of the containers. There is a layer lift sheet 20 for each layer of containers on the pallet.

FIG. 6 illustrates different types of lift sheets. Each of them spans the width and length intersection of the containers to hold the containers together under clamping pressure. All are attached to the container bottoms by glue or staples. The use of each will depend upon whether one or several lift sheets is desired to a pallet layer. It would be usual to use one lift sheet for a pallet layer. The lift sheet would extend across all the container intersections in the layer. The smaller versions could also be used.

Other changes may be made without departing from the spirit of the invention.

1. An array of containers comprising
a layer of a plurality of containers having side and end walls juxtaposed,
a sheet of corrugated board or fiberboard attached to the bottom of all the containers, holding the bottoms of the containers together,
the sheet of material having perforations aligned with the juxtaposed side and end walls of the containers.

2. The container array of claim 1 wherein the attachment of the sheet to the containers is by adhesive.

3. The container array of claim 1 wherein the attachment of the sheet to the containers is by staples.
